(19) United States
(12) Patent Application Publication
(10) Pub. No.: US 2009/0210146 A1
(43) Pub. Date: Aug. 20, 2009

(54) METHOD AND SYSTEM FOR GENERATING AN ITINERARY

(76) Inventor: Wei-Chuan Chen, Taipei (TW)

Correspondence Address: CHRISTIE, PARKER & HALE, LLP, PO BOX 7068, PASADENA, CA, 91109-7068, US

(21) Appl. No.: 12/372,652

(22) Filed: Feb. 17, 2009

(30) Foreign Application Priority Data
Feb. 19, 2008 (TW) 097105724

(51) Int. Cl. G01C 21/36

(52) U.S. Cl. 701/201; 701/209; 701/204

(57) ABSTRACT

A method for generating an itinerary to be implemented by a system includes: enabling the system to determine a route that starts at a departure point and that ends at a destination point with reference to an electronic route-providing source; enabling the system to determine at least one candidate place-of-interest located in the vicinity of the route with reference to an electronic place-of-interest providing source; and enabling the system to generate an itinerary that departs from the departure point and that arrives at the destination point via the route. The system includes the candidate place-of-interest as a to-be-visited place-of-interest into the itinerary based on an estimated travel time associated with the route, a duration of stay associated with the to-be-visited place-of-interest already included in the itinerary, and a duration of stay associated with the candidate place-of-interest. A system that performs the method is also disclosed.

### CROSS-REFERENCE TO RELATED APPLICATION

This application claims priority of Taiwanese application no. 097105724, filed on Feb. 19, 2008.

### BACKGROUND OF THE INVENTION

1. Field of the Invention

This invention relates to a method and system for generating an itinerary.

2. Description of the Related Art

In Taiwanese Patent Application No. 93108815, there is disclosed a conventional system that generates an itinerary, which departs at a start point and which arrives at an end point via a route, and which departs from the end point and which arrives at the start point. The drawback of the aforementioned conventional system is that the itinerary generated thereby does not include to-be-visited places-of-interest along the route.

In U.S. Pat. No. 5,802,492, there is disclosed a conventional system that generates an itinerary, which departs at a departure point and which arrives at a destination point via a route, and which includes user-selected to-be-visited places-of-interest along the route. The drawback of the aforementioned conventional system is that the itinerary generated thereby fails to take into account travel time for the route and visiting times for the to-be-visited places-of-interest.

### SUMMARY OF THE INVENTION

Therefore, the main object of the present invention is to provide a method for generating an itinerary that can overcome the aforesaid drawback of the prior art.

Another object of the present invention is to provide a system for generating an itinerary that can overcome the aforesaid drawback of the prior art.

According to an aspect of the present invention, a method for generating an itinerary to be implemented by a system comprises:

A) enabling the system to determine a route that starts at a departure point and that ends at a destination point with reference to an electronic route-providing source;

B) enabling the system to determine at least one candidate place-of-interest located in the vicinity of the route with reference to an electronic place-of-interest providing source, the candidate place-of-interest having a duration of stay associated therewith; and

C) enabling the system to generate an itinerary that departs from the departure point and that arrives at the destination point via the route, the system including the candidate place-of-interest as a to-be-visited place-of-interest into the itinerary based on an estimated travel time associated with the route, the duration of stay associated with the to-be-visited place-of-interest already included in the itinerary, and the duration of stay associated with the candidate place-of-interest.

According to another aspect of the present invention, a system for generating an itinerary comprises a storage module and a processing module. The storage module stores an electronic route-providing source that includes an electronic map, and an electronic place-of-interest providing source that includes a plurality of candidate places-of-interest, each of which has a duration of stay associated therewith. The processing module is coupled to the storage module, and is operable so as to obtain a departure point and a destination point, so as to determine a route that starts at the departure point and that ends at the destination point with reference to the electronic map of the electronic route-providing source, so as to determine at least one of the candidate places-of-interest of the electronic place-of-interest providing source located in the vicinity of the route, and so as to generate an itinerary that departs from the departure point and that arrives at the destination point via the route. The processing module includes the candidate place-of-interest as a to-be-visited place-of-interest into the itinerary based on an estimated travel time associated with the route, the duration of stay associated with the to-be-visited place-of-interest already included in the itinerary, and the duration of stay associated with the candidate place-of-interest.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a system for generating an itinerary according to this invention;

FIG. 2 is a schematic diagram of an itinerary generated by the preferred embodiment plotted on an electronic map;

FIGS. 3A to 4B are flowcharts of the preferred embodiment of a method for generating an itinerary to be implemented by the system shown in FIG. 1 according to this invention; and

FIG. 5 is a schematic diagram of a new itinerary generated by the preferred embodiment plotted on the electronic map.

### DETAILED DESCRIPTION OF THE PREFERRED EMBODIMENT

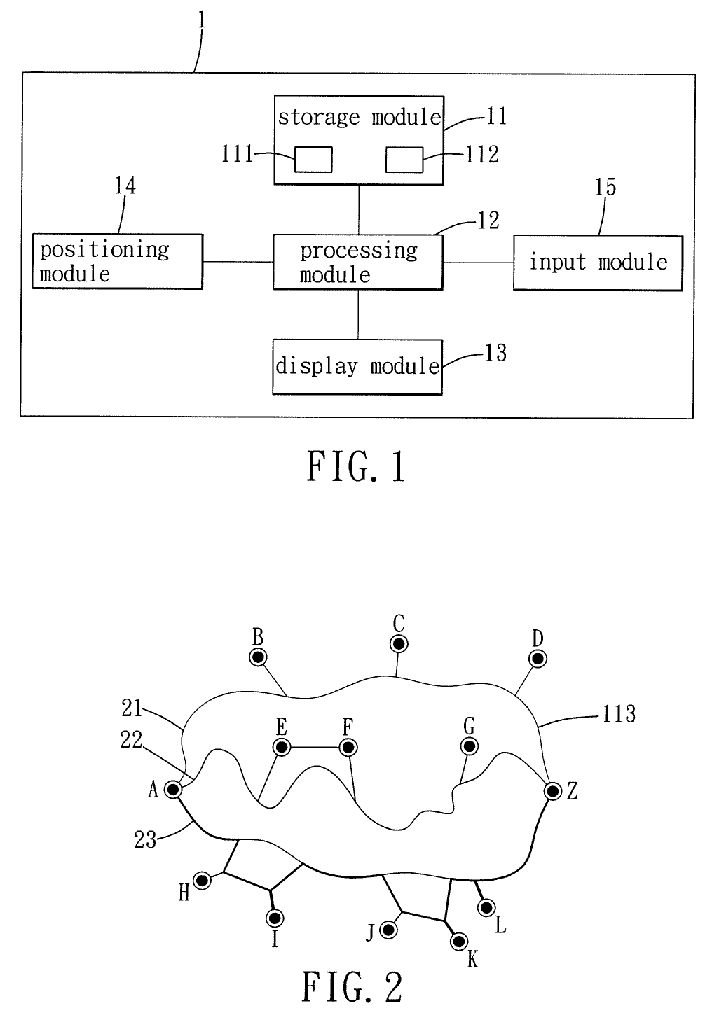

Referring to FIG. 1 and 2, the preferred embodiment of a system 1 according to this invention is shown to include a processing module 12, a storage module 11, a positioning module 14, a display module 13, and an input module 15.

The system 1, such as a navigating system, is installed in an electronic apparatus (not shown), such as a personal digital assistant (PDA), a mobile phone, or a navigating apparatus, and is operable so as to generate an itinerary, in a manner that will be described hereinafter.

In this embodiment, the processing module 12 may be a central processing unit (CPU) or an application-specific integrated circuit (ASIC).

The storage module 11 is connected to the processing module 12, and stores an electronic route-providing source 111 and an electronic place-of-interest providing source 112. The electronic route-providing source 111 includes an electronic map 113. The electronic place-of-interest providing source 112 includes a plurality of candidate places-of-interest (B to D, E to G, H to L), each of which has a weight assigned thereto and a duration of stay associated therewith.

The storage module 11 further stores program instructions, which when executed cause the processing module 12 to generate the itinerary. In this embodiment, the storage module 11 may be an internal storage module, such as a flash memory, or an external storage module, such as a compact disc (CD), a thumbdrive, or a portable hard disk.

It is noted that the weights assigned to the candidate places-of-interest (B to D, E to G, H to L) of the electronic place-of-interest providing source 112 are based on the popularity thereof. That is, the more popular the candidate place-of-interest (B to D, E to G, H to L) is, the higher is the weight assigned thereto. Moreover, each of the candidate places-of-interest (B to D, E to G, H to L) is preset in the electronic place-of-interest providing source 112 and is set therein by the system 1 or a user (not shown). Further, the weight assigned to and the duration of stay associated with each of the candidate places-of-interest (B to D, E to G, H to L) are preset in the electronic place-of-interest providing source 112 and may be set therein by the system 1 and then modified later by the user.

The positioning module 14 is connected to the processing module 12, and is operable so as to obtain a current location, i.e., latitude and longitude coordinates, of the processing module 12 from a global positioning system (GPS) (not shown) or a Galileo positioning system (not shown).

The display module 13 is connected to the processing module 12, and is operable so as to display the itinerary generated by the processing module 12.

The input module 15 is connected to the processing module 12, and is operable so as to accept inputs from the user. In this embodiment, the input module 15 may be a keypad or a touchscreen.

The system 1 further includes a real-time clock (RTC) (not shown) that is connected to the processing module 12 and that provides the time of day.

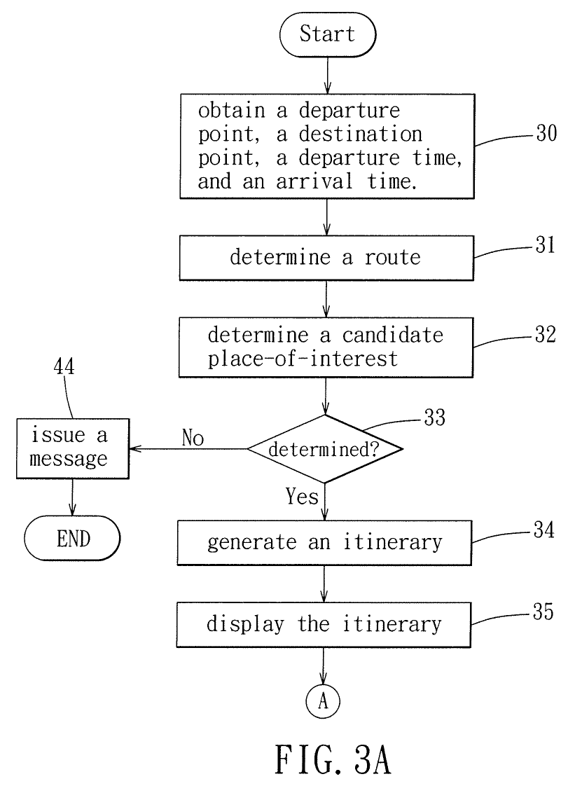

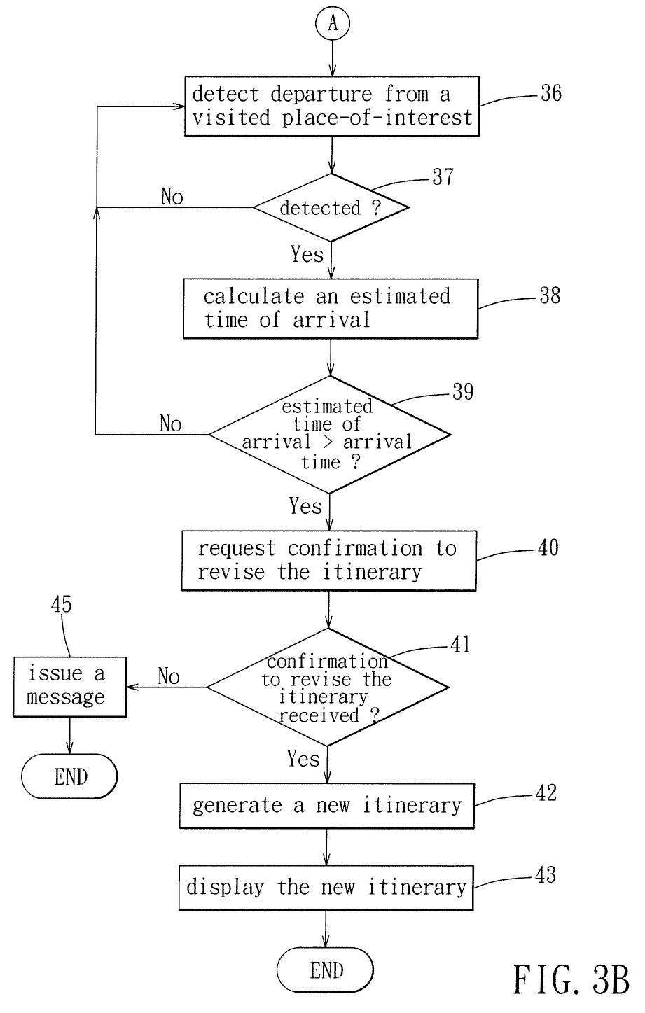

The preferred embodiment of a method for generating an itinerary to be implemented by the aforementioned system 1 according to this invention will now be described with further reference to FIGS. 3A and 3B.

In step 30, the processing module 12 of the system 1 obtains a departure point (A), a destination point (Z), a departure time associated with the departure point (A), and an arrival time associated with the destination point (Z).

In this step, the processing module 12 of the system 1 may obtain the departure point (A), the destination point (Z), the departure time, and the arrival time from the user through the input module 15 of the system 1. Moreover, in this step, the processing module 12 of the system 1 may obtain the departure point (A) from the global positioning system (GPS) through the positioning module 14 of the system 1. Further, in this step, the processing module 12 of the system 1 may obtain the departure time from the RTC of the system 1. In addition, in this step, the processing module 12 of the system 1 may obtain the destination point (Z) based on criteria inputted by the user through the input module 15 of the system 1.

In step 31, the processing module 12 of the system 1 determines a route that starts at the departure point (A) and that ends at the destination point (Z) with reference to the electronic map 113 of the electronic route-providing source 111.

In this step, since there are three routes 21, 22, 23 that start at the departure point (A) and that end at the destination point (Z) on the electronic map 113 of the electronic route-providing source 111, the processing module 12 of the system 1 determines a route by first calculating an estimated travel time associated with each of the routes 21, 22, 23, and then by selecting the route, which has the estimated time of arrival associated therewith that is earlier than the arrival time associated with the destination point (Z), e.g., the route 23.

Furthermore, in this step, the processing module 12 of the system 1 calculates the estimated travel time associated with each of the routes 21, 22, 23 based on a distance of a respective one of the routes 21, 22, 23 and an average speed value, such as sixty kilometers/hour. In this embodiment, the average speed value is preset in the system 1.

In an alternative embodiment, the average speed value is an actual speed value obtained by the processing module 12 of the system 1. In particular, the processing module 12 of the system 1 obtains the actual average speed value based on a plurality of locations thereof received thereby from the GPS via the positioning module 14 of the system 1, and a time interval between a consecutive pair of the locations thereof.

It is noted that, in this step, the processing module 12 of the system 1 may determine a route by first displaying the routes 21, 22, 23 through the display module 13 of the system 1 for selection by the user and then by receiving the route selected by the user through the input module 15 of the system 1.

In step 32, the processing module 12 of the system 1 determines at least one candidate place-of-interest located in the vicinity, i.e., within a 20-kilometer range, of the route 23 with reference to the candidate places-of-interest of the electronic place-of-interest providing source 112.

In step 33, when the processing module 12 of the system 1 determines the candidate place-of-interest in step 32, e.g., the candidate places-of-interest (H to L), the flow proceeds to step 34. Otherwise, when the processing module 12 of the system 1 fails to determine the candidate place-of-interest, the flow proceeds to step 44.

In step 34, the processing module 12 of the system 1 generates an itinerary that departs from the departure point (A) and that arrives at the destination point (Z) via the route 23.

In this step, the processing module 12 of the system 1 includes the candidate place-of-interest (H to L) as a to-be-visited place-of-interest into the itinerary when the summation of the estimated travel time associated with the route 23, the duration of stay associated with the to-be-visited place-of-interest already included in the itinerary, and the duration of stay associated with the candidate place-of-interest (H to L) is less than a time difference between the departure time associated with the departure point (A) and the arrival time associated with the destination point (Z).

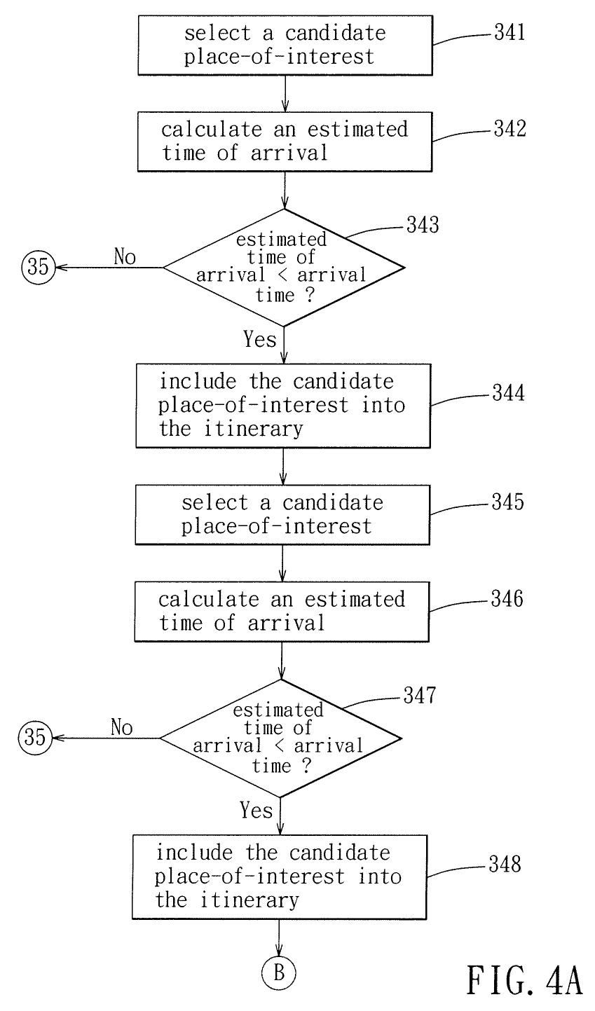

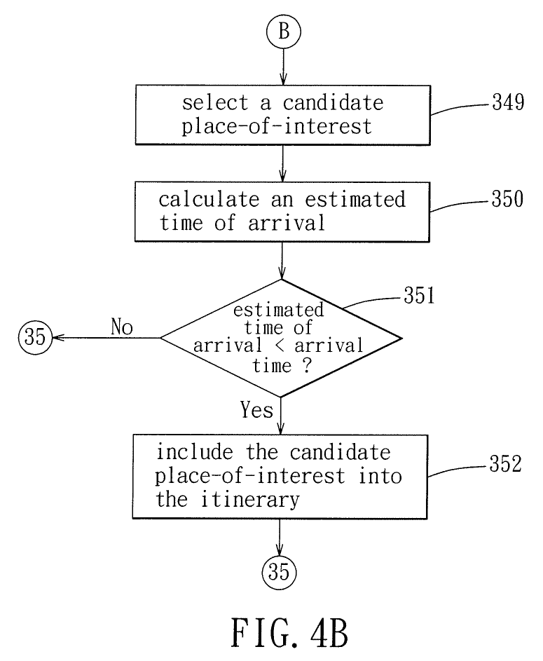

FIGS. 4A and 4B show the sub-steps of this step.

In sub-step 341, the processing module 12 of the system 1 selects the candidate place-of-interest (H to L), which has the highest weight, e.g., the candidate place-of-interest (I).

In sub-step 342, the processing module 12 of the system 1 calculates an estimated time of arrival at the destination point (Z) for the itinerary based on the estimated travel time associated with the route 23, the duration of stay associated with the candidate place-of-interest (I), and the departure time associated with the departure point (A).

In this sub-step, the processing module 12 of the system 1 first adds a distance between the departure point (A) and the candidate places-of-interest (I) and a distance between the candidate place-of-interest (I) and the destination point (Z), and then divides the sum thereof with the average speed value to obtain the estimated travel time associated with the route 23.

Furthermore, in this sub-step, the processing module 12 of the system 1 calculates the summation of the estimated travel time associated with the route 23, the duration of stay associated with the candidate place-of-interest (I), and the departure time associated with the departure point (A) to obtain the estimated time of arrival at the destination point (Z).

In sub-step 343, when the estimated time of arrival at the destination point (Z) calculated in sub-step 342 is earlier than the arrival time associated with the destination point (Z), the flow proceeds to sub-step 344. Otherwise, the flow proceeds to step 35.

In sub-step 344, the processing module 12 of the system 1 includes the candidate place-of-interest (I) as a to-be-visited place-of-interest into the itinerary.

In sub-step 345, the processing module 12 of the system 1 selects the candidate place-of-interest (J, K, L) between the to-be-visited place-of-interest (I) and the destination point (Z), which has the highest weight, e.g., the candidate place-of-interest (K). In sub-step 346, the processing module 12 of the system 1 calculates an estimated time of arrival at the destination point (Z) for the itinerary based on the estimated travel time associated with the route 23, the duration of stay associated with the to-be-visited place-of-interest (I) already included in the itinerary, the duration of stay associated with the candidate place-of-interest (K), and the departure time associated with the departure point (A).

In this sub-step, the processing module 12 of the system 1 first adds a distance between the departure point (A) and the to-be-visited place-of-interest (I), a distance between the to-be-visited place-of-interest (I) and the candidate place-of-interest (K), and a distance between the candidate place-of-interest (K) and the destination point (Z), and then divides the sum thereof with the average speed value to obtain the estimated travel time associated with the route 23.

Furthermore, in this sub-step, the processing module 12 of the system 1 calculates the summation of the estimated travel time associated with the route 23, the duration of stay associated with the to-be-visited place-of-interest (I), the duration of stay associated with the candidate place-of-interest (K), and the departure time associated with the departure point (A) to obtain the estimated time of arrival at the destination point (Z).

In sub-step 347, when the estimated time of arrival at the destination point (Z) calculated in sub-step 346 is earlier than the arrival time associated with the destination point (Z), the flow proceeds to sub-step 348. Otherwise, the flow proceeds to step 35.

In sub-step 348, the processing module 12 of the system 1 includes the candidate place-of-interest (K) as a to-be-visited place-of-interest into the itinerary.

In sub-step 349, the processing module 12 of the system 1 selects the candidate place-of-interest (L) between the to-be-visited place-of-interest (K) and the destination point (Z), which has the highest weight, i.e., the candidate place-of-interest (L).

In sub-step 350, the processing module 12 of the system 1 calculates an estimated time of arrival at the destination point (Z) for the itinerary based on the estimated travel time associated with the route 23, the duration of stay associated with the to-be-visited places-of-interest (I, K) already included in the itinerary, the duration of stay associated with the candidate place-of-interest (L), and the departure time associated with the departure point (A).

In this sub-step, the processing module 12 of the system 1 first adds a distance between the departure point (A) and the to-be-visited place-of-interest (I), a distance between the to-be-visited places-of-interest (I, K), a distance between the to-be-visited place-of-interest (K) and the candidate place-of-interest (L), and a distance between the candidate place-of-interest (L) and the destination point (Z), and then divides the sum thereof with the average speed value to obtain the estimated travel time associated with the route 23.

Furthermore, in this sub-step, the processing module 12 of the system 1 calculates the summation of the estimated travel time associated with the route 23, the duration of stay associated with the to-be-visited places-of-interest (I, K) and the candidate place-of-interest (L), and the departure time associated with the departure point (A) to obtain the estimated time of arrival at the destination point (Z).

In sub-step 351, when the estimated time of arrival at the destination point (Z) calculated in sub-step 350 is earlier than the arrival time associated with the destination point (Z), the flow proceeds to the sub-step 352. Otherwise, the flow proceeds to step 35.

In sub-step 352, the processing module 12 of the system 1 includes the candidate place-of-interest (L) as a to-be-visited place-of-interest into the itinerary.

Referring once again to FIGS. 3A and 3B, alternatively, in step 30, the processing module 12 of the system 1 may obtain a desired travel time associated with the departure point (A) and the destination point (Z) based on the departure time and the arrival time or from the user through the input module 15 of the system 1, and in step 34, the processing module 12 of the system 1 includes the candidate place-of-interest (H to L) into the itinerary when the summation of the estimated travel time associated with the route 23, the duration of stay associated with the to-be-visited place-of-interest already included in the itinerary, and the duration of stay associated with the candidate place-of-interest (H to L) is less than the desired travel time between the departure point (A) and the destination point (Z).

In step 35, the display module 13 of the system 1 displays the departure point (A), the destination point (Z), the route 23, and the to-be-visited place-of-interest in the itinerary, e.g., the to-be-visited places-of-interest (I, K, L), either on the electronic map 113 of the electronic route-providing source 111 or simply as texts.

It is noted that, in this step, the display module 13 of the system 1 may further display the duration of stay associated with each of the to-be-visited places-of-interest (I, K, L).

In step 36, the processing module 12 of the system 1 detects departure from a visited one of the places-of-interest in the itinerary, e.g., the visited place-of-interest (I).

In this step, the processing module 12 of the system 1 detects departure from the visited place-of-interest (I) only when a current location of the processing module 12 of the system 1 is at at least a predetermined distance, e.g., 10 kilometers, from the visited place-of-interest (I).

In step 37, when the processing module 12 of the system 1 detects the departure from the visited place-of-interest (I), the flows proceeds to step 38. Otherwise, the flow goes back to step 36.

In step 38, the processing module 12 of the system 1 calculates an estimated time of arrival at the destination point (Z) based on an estimated remaining travel time associated with the route 23, the duration of stay associated with each of to-be-visited places-of-interest (K, L) in the itinerary, and the time of day.

In step 39, when the estimated time of arrival calculated in step 38 is later than the arrival time associated with the destination point (Z), the flow proceeds to step 40. Otherwise, the flow goes back to step 36 to detect departure from a next visited place-of-interest.

In step 40, the processing module 12 of the system 1 requests confirmation from the user whether or not to revise the to-be-visited places-of-interest (K, L) in the itinerary.

In step 41, when the processing module 12 of the system 1 receives the confirmation from the user to revise the to-be-visited places-of-interest (K, L) in the itinerary through the input module 15 of the system 1, the flow proceeds to step 42. Otherwise, i.e., the processing module 12 of the system 1 receives the confirmation not to revise the to-be-visited places-of-interest through the input module 15 of the system 1, the flow proceeds to step 45.

In step 42, the processing module 12 of the system 1 generates a new itinerary that departs at a current location of the processing module 12 of the system 1 and that arrives at the destination point (Z) via the route 23.

In this step, the processing module 12 of the system 1 includes the candidate place-of-interest (J, K, L) between the visited place-of-interest (I) and the destination point (Z) as a to-be-visited place-of-interest into the new itinerary when the summation of the estimated travel time associated with the route 23, the duration of stay associated with the to-be-visited place-of-interest already included in the itinerary, and the duration of stay associated with the candidate place-of-interest (J, K, L) is less than a time difference between the time of day and the arrival time associated with the destination point (Z).

In this embodiment, step 42 includes the following sub-steps:

421) enabling the processing module 12 of the system 1 to select the candidate place-of-interest (J, K, L), which has the highest weight, e.g., the candidate place-of-interest (K);

422) enabling the processing module 12 of the system 1 to calculate an estimated time of arrival at the destination point (Z) for the itinerary based on the estimated travel time associated with the route 23, the duration of stay associated with the candidate place-of-interest (K), and the time of day;

423) when the estimated time of arrival at the destination point (Z) calculated in sub-step 422) is earlier than the arrival time associated with the destination point (Z), which is, for instance, the case in this sub-step, enabling the processing module 12 of the system 1 to include the candidate place-of-interest (K) as a to-be-visited place-of-interest into the new itinerary;

424) enabling the processing module 12 of the system 1 to select the candidate place-of-interest (L) between the to-be-visited place-of-interest (K) and the destination point (Z), which has the highest weight, i.e., the candidate place-of-interest (L);

425) enabling the processing module 12 of the system 1 to calculate an estimated time of arrival at the destination point (Z) for the itinerary based on the estimated travel time associated with the route 23, the duration of stay associated with the to-be-visited place-of-interest (K) already included in the itinerary, the duration of stay associated with the candidate place-of-interest (L), and the time of day; and

426) when the estimated time of arrival at the destination point (Z) calculated in sub-step 425) is earlier than the arrival time associated with the destination point (Z), enabling the processing module 12 of the system 1 to include the candidate place-of-interest (L) as a to-be-visited place-of-interest into the new itinerary.

It is noted that, for the above example, since the estimated time of arrival at the destination point (Z) calculated in step 38 is later than the arrival time associated with the destination point (Z), the estimated time of arrival at the destination point (Z) calculated in sub-step 425) is therefore later than the arrival time associated with the destination point (Z). Hence, in this sub-step, the candidate place-of-interest (L) is not included as a to-be-visited place-of-interest into the new itinerary.

In step 43, the display module 13 of the system 1 displays the current location of the processing module 12 of the system 1, the destination point (Z), the route 23, and the to-be-visited place-of-interest (K) in the new itinerary either on the electronic map 113 of the electronic route-providing source 111 or simply as texts. Thereafter, the flow is terminated.

In step 44, the processing module 12 of the system 1 issues a message that is displayed on the display module 13 of the system 1, that informs the user that there is no candidate place-of-interest in the vicinity of the route 23, and that instructs the user to go directly to the destination point (Z) via the route 23. Thereafter, the flow is terminated.

In step 45, the processing module 12 of the system 1 issues a message that is displayed on the display module 13 of the system 1 and that instructs the user to go directly to the destination point (Z) via the route 23. Thereafter, the flow is terminated.

The method further includes the step of enabling the processing module 12 of the system 1 to issue a warning a predetermined time period before the duration of stay associated with a currently visited place-of-interest (H to L) in the itinerary elapses.

Furthermore, the method includes the steps of:

when the processing module 12 of the system 1 detects departure from the departure point (A), enabling the processing module 12 of the system 1 to periodically calculate an estimated time of arrival at the destination point (Z) based on a current location thereof, an average speed value, the duration of stay associated with each of the to-be-visited places-of-interest (H to L) in the itinerary, and the time of day; and

when the estimated time of arrival calculated thereby is later than the arrival time associated with the destination point (Z), enabling the system 1 to issue a warning.

It is noted that, in an alternative embodiment, steps 40 and 41 may be skipped. That is, when it is determined in step 39 that the estimated time of arrival calculated in step 38 is later than the arrival time associated with the destination point (Z), the flow proceeds directly to step 42.

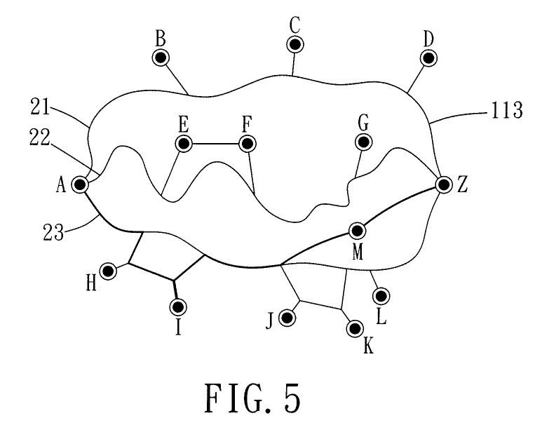

It is noted further that, in step 42, when the processing module 12 of the system 1 fails to include the candidate place-of-interest (J, K, L) into the new itinerary, the processing module 12 of the system 1 issues a message that is displayed on the display module 13 of the system 1 and that instructs the user to go directly to the destination point (Z) via the route 23. Moreover, in step 42, the processing module 12 of the system 1 may generate the new itinerary by simply removing one of the to-be-visited places-of-interest (K, L) such that an estimated time of arrival at the destination point (Z) calculated thereby based on the estimated travel time associated with the route 23, the duration of stay associated with a retained one of the to-be-visited places-of-interest (K, L), and the time of day is earlier than the arrival time associated with the destination point (Z). Further, instep 42, with additional reference to FIG. 5, the processing module 12 of the system 1 may include a new candidate place-of-interest (M) between the visited place-of-interest (I) and the destination point (Z) as a to-be-visited place-of-interest into the new itinerary such that an estimated time of arrival at the destination point (Z) calculated thereby based on the estimated travel time associated with the route 23, the duration of stay associated with the new candidate place-of-interest (M) and the time of day is earlier than the arrival time associated with the destination point (Z).

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for generating an itinerary to be implemented by a system, said method comprising:
A) enabling the system to determine a route that starts at a departure point and that ends at a destination point with reference to an electronic route-providing source;
B) enabling the system to determine at least one candidate place-of-interest located in the vicinity of the route with reference to an electronic place-of-interest providing source, the candidate place-of-interest having a duration of stay associated therewith; and
C) enabling the system to generate an itinerary that departs from the departure point and that arrives at the destination point via the route, the system including the candidate place-of-interest as a to-be-visited place-of-interest into the itinerary based on an estimated travel time associated with the route, the duration of stay associated with the to-be-visited place-of-interest already included in the itinerary, and the duration of stay associated with the candidate place-of-interest.

2. The method as claimed in claim 1, wherein, in step C), the system includes the candidate place-of-interest into the itinerary based further on a departure time associated with the departure point, and an arrival time associated with the destination point, said method further comprising:
D) enabling the system to obtain the departure point, the destination point, the departure time associated with the departure point, and the arrival time associated with the destination point prior to step A).

3. The method as claimed in claim 2, further comprising:
E) when the system detects departure from a visited one of the places-of-interest in the itinerary, enabling the system to calculate an estimated time of arrival at the destination point based on an estimated remaining travel time associated with the route, the duration of stay associated with each of the to-be-visited places-of-interest in the itinerary, and the time of day; and
F) when the estimated time of arrival calculated in step E) is later than the arrival time associated with the destination point, enabling the system to request confirmation whether or not to revise the to-be-visited places-of-interest in the itinerary.

4. The method as claimed in claim 3, further comprising: G) when the system receives the confirmation to revise the to-be-visited places-of-interest in the itinerary, enabling the system to generate a new itinerary that departs at a current location thereof and that arrives at the destination point via the route, the system including the candidate place-of-interest between the visited one of the places-of-interest and the destination point as a to-be-visited place-of-interest into the new itinerary based on the estimated remaining travel time associated with the route, the duration of stay associated with the candidate place-of-interest, the time of day, and the arrival time associated with the destination point.

5. The method as claimed in claim 4, wherein the system is enabled to issue a message when the system fails to include the candidate place-of-interest into the new itinerary in step G).

6. The method as claimed in claim 2, further comprising:
E) when the system detects departure from a visited one of the places-of-interest in the itinerary, enabling the system to calculate an estimated time of arrival at the destination point based on an estimated remaining travel time associated with the route, the duration of stay associated with each of the to-be-visited places-of-interest in the itinerary, and the time of day; and
F) when the estimated time of arrival calculated in step E) is later than the arrival time associated with the destination point, enabling the system to generate a new itinerary that departs at a current location thereof and that arrives at the destination point via the route, the system including the candidate place-of-interest between the visited one of the places-of-interest and the destination point as a to-be-visited place-of-interest into the new itinerary based on the estimated remaining travel time associated with the route, the duration of stay associated with the candidate place-of-interest, the time of day, and the arrival time associated with the destination point.

7. The method as claimed in claim 6, wherein the system is enabled to issue a message when the system fails to include the candidate place-of-interest into the new itinerary in step F).

8. The method as claimed in claim 2, further comprising:
E) when the system detects departure from the departure point, enabling the system to periodically calculate an estimated time of arrival at the destination point based on a current location thereof, the duration of stay associated with each of the to-be-visited places-of-interest in the itinerary, and the time of day; and
F) when the estimated time of arrival calculated in step E) is later than the arrival time associated with the destination point, enabling the system to issue a warning.

9. The method as claimed in claim 2, wherein step C) includes the sub-steps of: c1) enabling the system to calculate an estimated time of arrival at the destination point for the itinerary based on the estimated travel time associated with the route, the duration of stay associated with the to-be-visited place-of-interest already included in the itinerary, the duration of stay associated with the candidate place-of-interest, and the departure time associated with the departure point; and
c2) when the estimated time of arrival at the destination point calculated in sub-step c1) is earlier than the arrival time associated with the destination point, enabling the system to include the candidate place-of-interest into the itinerary.

10. The method as claimed in claim 2, wherein, in step C), the system includes the candidate place-of-interest into the itinerary when the summation of the estimated travel time associated with the route, the duration of stay associated with the to-be-visited place-of-interest already included in the itinerary, and the duration of stay associated with the candidate place-of-interest is less than a time difference between the departure time associated with the departure point and the arrival time associated with the destination point.

11. The method as claimed in claim 1, wherein, in step C), the system includes the candidate place-of-interest into the itinerary based further on a desired travel time between the departure point and the destination point, said method further comprising:
D) enabling the system to obtain the departure point, the destination point, and the desired travel time between the departure point and the destination point prior to step A).

12. The method as claimed in claim 11, wherein, in step D), the system is further enabled to obtain a departure time associated with the departure point and an arrival time associated with the destination point, and the desired travel time between the departure point and the destination point is based on the departure time and the arrival time obtained thereby.

13. The method as claimed in claim 11, wherein, in step C), the system includes the candidate place-of-interest into the itinerary when the summation of the estimated travel time associated with the route, the duration of stay associated with the to-be-visited place-of-interest already included in the itinerary, and the duration of stay associated with the candidate place-of-interest is less than the desired travel time between the departure point and the destination point.

14. The method as claimed in claim 1, wherein, in step C), the estimated travel time associated with the route is calculated based on a distance of the route and an actual speed value obtained by the system.

15. The method as claimed in claim 1, further comprising:
D) enabling the system to issue a message a predetermined time period before the duration of stay associated with a currently visited place-of-interest in the itinerary elapses.

16. A system for generating an itinerary, comprising:
a storage module storing
an electronic route-providing source that includes an electronic map, and
an electronic place-of-interest providing source that includes a plurality of candidate places-of-interest, each of which has a duration of stay associated therewith; and
a processing module coupled to said storage module, and operable so as to obtain a departure point and a destination point, so as to determine a route that starts at the departure point and that ends at the destination point with reference to the electronic map of said electronic route-providing source, so as to determine at least one of the candidate places-of-interest of said electronic place-of-interest providing source located in the vicinity of the route, and so as to generate an itinerary that departs from the departure point and that arrives at the destination point via the route, said processing module including the candidate place-of-interest as a to-be-visited place-of-interest into the itinerary based on an estimated travel time associated with the route, the duration of stay associated with the to-be-visited place-of-interest already included in the itinerary, and the duration of stay associated with the candidate place-of-interest.

17. The system as claimed in claim 16, wherein:
said processing module is further operable so as to obtain a departure time associated with the departure point, and an arrival time associated with the destination point; and
said processing module includes the candidate place-of-interest into the itinerary based further on the departure time associated with the departure point and the arrival time associated with the destination point.

18. The system as claimed in claim 17, wherein:
said processing module is further operable so as to detect departure from a visited one of the places-of-interest in the itinerary;
when said processing module detects the departure from the visited one of the places-of-interest in the itinerary, said processing module calculates an estimated time of arrival at the destination point based on an estimated remaining travel time associated with the route, the duration of stay associated with each of the to-be-visited places-of-interest in the itinerary, and the time of day; and
when the estimated time of arrival calculated by said processing module is later than the arrival time associated with the destination point, said processing module requests confirmation whether or not to revise the to-be-visited places-of-interest in the itinerary.

19. The system as claimed in claim 18, wherein:
when said processing module receives the confirmation to revise the to-be-visited places-of-interest in the itinerary, said processing module generates anew itinerary that departs at a current location thereof and that arrives at the destination point via the route; and
said processing module includes the candidate place-of-interest between the visited one of the places-of-interest and the destination point as a to-be-visited place-of-interest into the new itinerary based on the estimated remaining travel time associated with the route, the duration of stay associated with the candidate place-of-interest, the time of day, and the arrival time associated with the destination point.

20. A computer program product comprising:
a machine readable storage medium having program instructions stored therein which when executed cause a system to perform a set of operations including:
determining a route that starts at a departure point and that ends at a destination point with reference to an electronic route-providing source;
determining at least one candidate place-of-interest located in the vicinity of the route with reference to an electronic place-of-interest providing source, the candidate place-of-interest having a duration of stay associated therewith; and
generating an itinerary that departs from the departure point and that arrives at the destination point via the route, the candidate place-of-interest being included as a to-be-visited place-of-interest into the itinerary based on an estimated travel time associated with the route, the duration of stay associated with the to-be-visited place-of-interest already included in the itinerary, and the duration of stay associated with the candidate place-of-interest.
